(19) United States
(12) Patent Application Publication
(10) Pub. No.: US 2014/0036327 A1
(43) Pub. Date: Feb. 6, 2014

(54) HOLOGRAM AUTHENTICATION SYSTEM

(71) Applicant: ALPS ELECTRIC CO., LTD., Tokyo (JP)

(72) Inventors: Yoshihiro SOMENO, Miyagi-Ken (JP); Junichi UMEHARA, Tokyo (JP); Kenichi NAKAJIMA, Tokyo (JP); Kaname MIKI, Tokyo (JP); Hideyoshi HORIMAI, Kanagawa (JP)

(21) Appl. No.: 13/950,836

(22) Filed: Jul. 25, 2013

(30) Foreign Application Priority Data
Jul. 31, 2012 (JP) 2012-169422

(51) Int. Cl. G03H 1/00

(52) U.S. Cl. CPC G03H 1/0011
USPC 359/2

(57) ABSTRACT

An authentication system includes a first hologram, a second hologram, a light source, and an image pickup device. In this case, the first hologram is a transmission hologram for causing interference with data of the second hologram in order to authenticate the second hologram, the second hologram is a reflection hologram to be authenticated, and light from the light source is reflected by the second hologram, the reflected light is irradiated to the first hologram as reference light for the first hologram. Diffracted light through the first hologram is acquired by the image pickup device to authenticate the second hologram.

### CLAIM OF PRIORITY

This application claims benefit of Japanese Patent Application No. 2012-169422 filed on Jul. 31, 2012, which is hereby incorporated by reference in its entirety.

### BACKGROUND

1. Field of the Disclosure

The present disclosure relates to a system which authenticates a hologram given to a personal ID card, for example.

2. Description of the Related Art

Japanese Unexamined Patent Application Publication No. 6-110377 discloses an invention relating to a checking method and checking apparatus using holograms.

As illustrated in FIG. 1 in Japanese Unexamined Patent Application Publication No. 6-110377, light from a light source 2 is radiated to a first hologram 10, and reproduced light 3 from the first hologram 10 is irradiated to a second hologram 30. Diffracted light 4 from the second hologram 30 is read as data 5.

According to Japanese Unexamined Patent Application Publication No. 6-110377, the second hologram 30 is attached to a card 1 such as a credit card. When the card 1 is held over a checking apparatus, reproduced light 3 transmitted through the first hologram 10 functions as reference light to the second hologram 30 so that diffracted light, resulting from interference between data pieces from the first hologram 10 and second hologram 30 may be acquired.

According to Japanese Unexamined Patent Application Publication No. 6-110377, it is disclosed in Section [Advantages of the Invention] that because a side having one hologram to be checked is prohibited to acquire, only with the one hologram, checking data held by a side which has another hologram, forgery is in fact impossible, which may significantly improve the effect of preventing forgery.

However, according to the checking apparatus using holograms disclosed in Japanese Unexamined Patent Application Publication No. 6-110377, because light (reproduced light 3) leaks from the first hologram 10 to the outside, data recorded in the first hologram 10 may possibly be stolen from the reproduced light 3.

### SUMMARY

An authentication system includes a first hologram, a second hologram, a light source, and an image pickup device, wherein the first hologram is a transmission hologram for causing interference with data of the second hologram in order to authenticate the second hologram, the second hologram is a reflection hologram to be authenticated, and light from the light source is reflected by the second hologram, the reflected light is irradiated to the first hologram as reference light for the first hologram, and diffracted light through the first hologram is acquired by the image pickup device to authenticate the second hologram. According to the present invention, after light from a light source is reflected by the second hologram, the reflected light is irradiated as reference light to the first hologram. The diffracted light through the first hologram is acquired by an image pickup device as interference fringes resulting from interference of data recorded in both of the first hologram and the second hologram. The data of the interference fringes acquired in the image pickup device and saved data are compared. If they are matched, it is determined that the second hologram is authentic. If not, it is determined that the second hologram is an imitation. The present invention may prevent external leakage of data of the first hologram for interference with data of the second hologram. In this way, according to the present invention, an authentication system with higher security than before may be implemented which may prevent leakage of data recorded on the first hologram.

### BRIEF DESCRIPTION OF THE DRAWINGS

FIG. 1 is a schematic diagram of a hologram authentication system according to a first embodiment of the present invention;

FIG. 2 is a schematic diagram of a hologram authentication system according to a second embodiment of the present invention;

FIG. 3 is a schematic diagram of a hologram authentication system according to a third embodiment of the present invention;

FIG. 4 is a schematic diagram of a hologram authentication system according to a fourth embodiment of the present invention;

FIG. 5 is a schematic diagram of a hologram authentication system according to a fifth embodiment of the present invention;

FIG. 6 is a schematic diagram of a hologram authentication system according to a sixth embodiment of the present invention; and

FIG. 7 is a schematic diagram of a hologram authentication system according to a seventh embodiment of the present invention.

### DESCRIPTION OF THE EXEMPLARY EMBODIMENTS

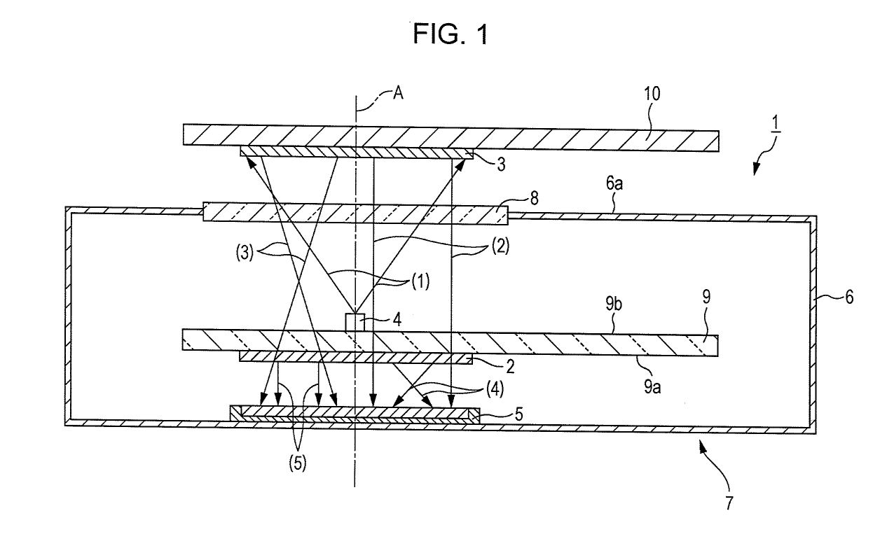

FIG. 1 is a schematic diagram of a hologram authentication system according to a first embodiment of the present invention.

A hologram authentication system 1 illustrated in FIG. 1 includes a first hologram 2, a second hologram 3, a light source 4, and an image pickup device 5.

According to the first embodiment illustrated in FIG. 1, the first hologram 2, light source 4 and the image pickup device 5 may be built within one housing 6 to configure a body 7.

As illustrated in FIG. 1, within the body 7, the first hologram 2 may be arranged between the light source 4 and the image pickup device 5.

As illustrated in FIG. 1, the housing 6 may have a top surface 6a, which is close to the light source 4, having a transmission window 8. The transmission window 8 contains a material through which light from the light source 4 may be transmitted. The second hologram 3 may be held over the transmission window 8.

FIG. 1 illustrates a state that the second hologram 3 is held over the transmission window 8 of the body 7 for authentication of the second hologram 3.

As illustrated in FIG. 1, the first hologram 2, second hologram 3, light source 4 and image pickup device 5 are arranged on a same axis A. These components are spaced apart in the direction to the axis A. The expression “on a same axis A” refers to a state that the centers of the components of the first hologram 2, second hologram 3, light source 3 and image pickup device 5 are aligned coaxially. The expression “on a same axis” may also be defined as “on a same optical axis”. The expression “on a same axis” may allow a slight displacement due to a manufacturing error. As illustrated in FIG. 1, the image pickup device 5, first hologram 2, light source 4, and second hologram 3 are placed in order from the bottom to the top of the figure.

The first hologram 2 illustrated in FIG. 1 is provided on a bottom face 9a of a plate 9 having a predetermined thickness. The light source 4 is provided on a top surface 9b of the plate 9. In this way, the first hologram 2 and the light source 4 may be provided on the front and back faces of the same plate 9.

The plate 9 is made of a light-transmissive material. This is because the plate 9 may be necessary to allow light to transmit through as illustrated in FIG. 1.

The plate 9 is fixed and is supported by a support member, not illustrated, within the body 7.

The first hologram 2 is a transmission hologram, and the second hologram 3 is a reflection hologram.

A transmission hologram and a reflection hologram may be acquired by changing the directions of interference fringes about the direction of thickness within a hologram recording layer by changing the directions of irradiation of reference light and object light about the hologram recording layer when data is recorded to the hologram recording layer, and they may be produced by an existing method.

The second hologram 3 is provided on a card 10. The card 10 may be a personal ID card such as a credit card or a card key, for example, but may not be limited to any particular type.

The second hologram 3 is subject to an authentication such as a personal authentication in the authentication system 1 in FIG. 1. On the other hand, the first hologram 2 plays a role of a what-is-called master key for generating interference fringes functioning as authentication data. Data of the first hologram 2 is interfered with the data of the second hologram 3 to authenticate the second hologram 3. For example, when the card 10 is a card key for an apartment, the card 10 is carried by a resident. The plate 9 having the first hologram 2 or the body 7 having the first hologram 2 may be held by a manager of an apartment or may be equipped at an entrance of an apartment.

As illustrated in FIG. 1, reference light (1) emitted from the light source 4 is irradiated to the second hologram 3 through the transmission window 8. The reference light (1) is diffracted by interference fringes of the second hologram 3 that is a reflection hologram, and reflected light beams (diffracted light beams) (2) and (3) may be acquired.

According to the embodiment in FIG. 1, the second hologram 3 records a plurality of different data pieces. A plurality of reflected light beams (diffracted light beams) and (3) diffracted by the interference fringes of the data pieces may be acquired. In FIG. 1, the reflected light beams (diffracted light beams) (2) are parallel rays, and the reflected light beams (diffracted light beams) (3) are diverging rays.

The reflected light beams (diffracted light beams) (2) and (3) contain phase data and intensity-of-light data. As illustrated in FIG. 1, the reflected light beams (diffracted light beams) (2) and (3) reach the first hologram 2. The reflected light beams (diffracted light beams) (2) and (3) act as reference light to the first hologram 2. Because the first hologram 2 is a transmission hologram, light transmits through the first hologram 2 in the direction of thickness as illustrated in FIG. 1 so that a plurality of diffracted light beams (4) and (5) may be obtained from the bottom surface side of the first hologram 2.

The diffracted light beams (4) and (5) obtained from the first hologram 2 are resulted from interference with data of the second hologram 3. In other words, the interference fringes to be read by the image pickup device 5 appear as composite data of the first hologram 2 and the second hologram 3 in which waves are strengthen each other at a part where phases of data pieces of the first hologram 2 and the second hologram 3 are matched and waves are weaken each other in a part where phases are different.

The image pickup device 5 is an image sensor such as a CCD or a CMOS. Whether the image data read by the image pickup device 5 is matched with a pre-registered image data or not is determined. If they are matched, the second hologram 3 is determined as authentic. If not, it is determined as an imitation.

The authentication system 1 illustrated in FIG. 1 has a control unit, which registers image data and compares between image data pieces. For example, an image data process (algorithm) using a look-up table may be performed.

According to the embodiment illustrated in FIG. 1, after light (reference light) (1) from the light source 4 is reflected by the second hologram 3, the reflected light beams (2) and (3) are irradiated to the first hologram 2 as reference light. The diffracted light beams (4) and (5) transmitted through the first hologram 2 are acquired by the image pickup device 5 as interference fringes resulting from interference of data pieces recorded in both of the first hologram 2 and the second hologram 3. The authentication system 1 of this embodiment may prevent external leakage of data of the first hologram 2 for interference with data of the second hologram 3. Thus, the authentication system 1 having higher security than before may be provided which may prevent leakage of data recorded on the first hologram 2.

As illustrated in FIG. 1, according to this embodiment, the first hologram 2, light source 4, second hologram 3 and image pickup device 5 are arranged on the same axis A. Thus, all of the light (reference light) (1) from the light source 4, the reflected light beams (diffracted light beams) (2) and (3) from the second hologram 3, and the diffracted light beams (4) and (5) from the first hologram 2 have an optical axis in a same direction (matched with the axis A). Arranging the components on the same axis A may thus reduce the size of the authentication system 1 rather than displacing the components in a lateral direction (direction orthogonal to the axis A, such as a direction orthogonal to the optical axis).

As illustrated in FIG. 1, the first hologram 2 and light source 4 may be arranged between the second hologram 3 and the image pickup device 5. Also in FIG. 1, the first hologram 2 may be arranged between the light source 4 and the image pickup device 5. Thus, an optical system may easily be acquired which may irradiate light (reference light) (1) from the light source 4 to the second hologram 3 without through the first hologram 2 and then irradiate the reflected light beams (diffracted light beams) (2) and (3) from the second hologram 3 as reference light to the first hologram 2. In order to acquire such an optical system, the components may be arranged on the same axis A, which may effectively reduce the size of the authentication system 1, without requiring a particular idea.

In FIG. 1, the first hologram 2 and the light source 4 are arranged on the same plate 9. As illustrated in FIG. 1, arranging the first hologram 2 and the light source 4 on the front and back faces of the plate 9 may provide the first hologram 2 and the light source 4 on the same axis A so that the first hologram 2 and the light source 4 may be aligned properly and easily. In addition, the first hologram 2 and light source 4 may not be supported separately, but a support mechanism which supports the plate 9 may only be required, which may simplify and reduce the size of the support mechanism.

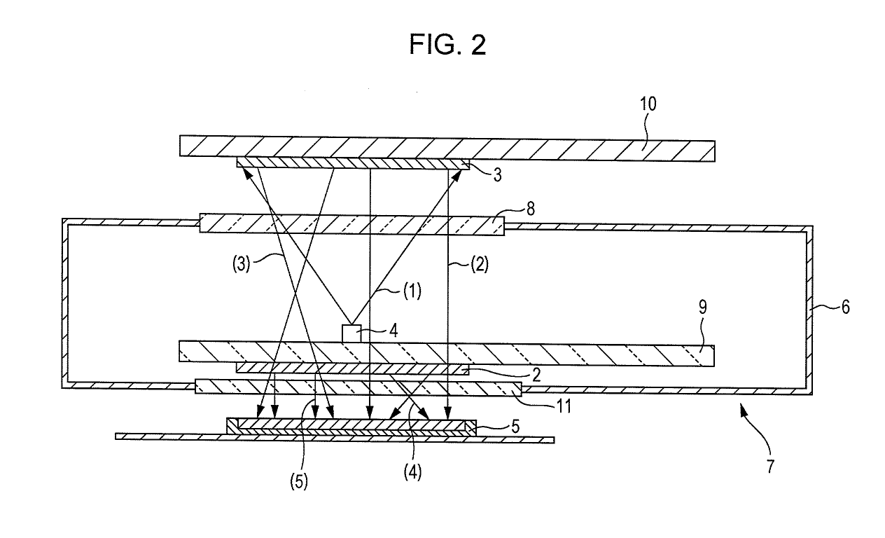

In FIG. 1, the first hologram 2, light source 4, and image pickup device 5 are built in the same housing 6 to configure the body 7. However, as illustrated in FIG. 2 (illustrating a variation example of the configuration illustrated in FIG. 1), the first hologram 2 and light source 4 are arranged in the body 7, and the body 7 may be externally mounted to the image pickup device 5.

In the configuration illustrated in FIG. 2, the bottom face 6b of the housing 6 (close to the first hologram 2) has a transmission window 11, which allows light to transmit through. The diffracted light beams (4) and (5) from the first hologram 2 transmits through the transmission window 11 and is acquired by the image pickup device 5.

The image pickup device 5 illustrated in FIG. 2 may be a digital camera attached to an electronic apparatus but is not limited thereto in particular.

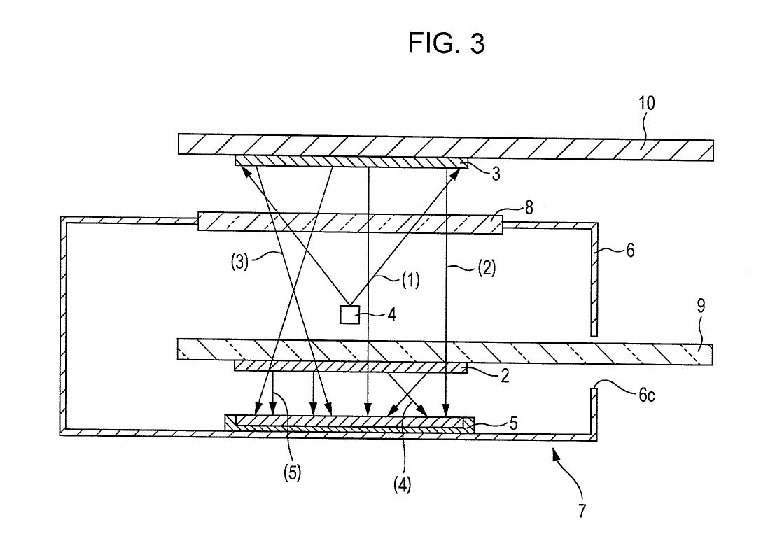

FIG. 3 illustrates a partial variation of the configuration illustrated in FIG. 1. In FIG. 3, the light source 4 is provided separately from the plate 9. The light source 4 may be fixed and is supported by a support mechanism, not illustrated, within the housing 6. In the configuration illustrated in FIG. 3, the housing 6 may have an insertion opening 6c to which the plate 9 having the first hologram 2 is insertable to replace the plate 9. In the configuration in FIG. 3, the first hologram 2 corresponding to a master key may be changed as required.

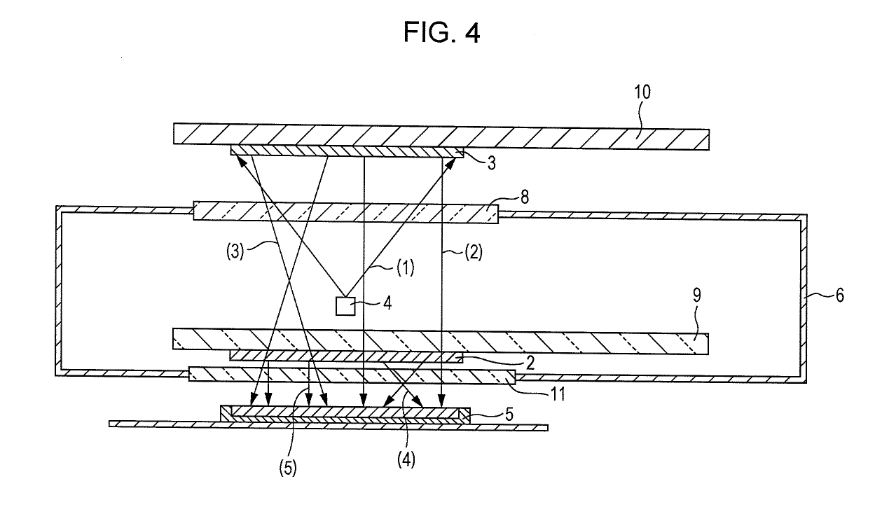

FIG. 4 illustrates a variation example of the configuration in FIG. 3 and illustrates a configuration in which the body 7 having the first hologram 2 and the light source 4 may be externally provided to the image pickup device 5, as illustrated in FIG. 2.

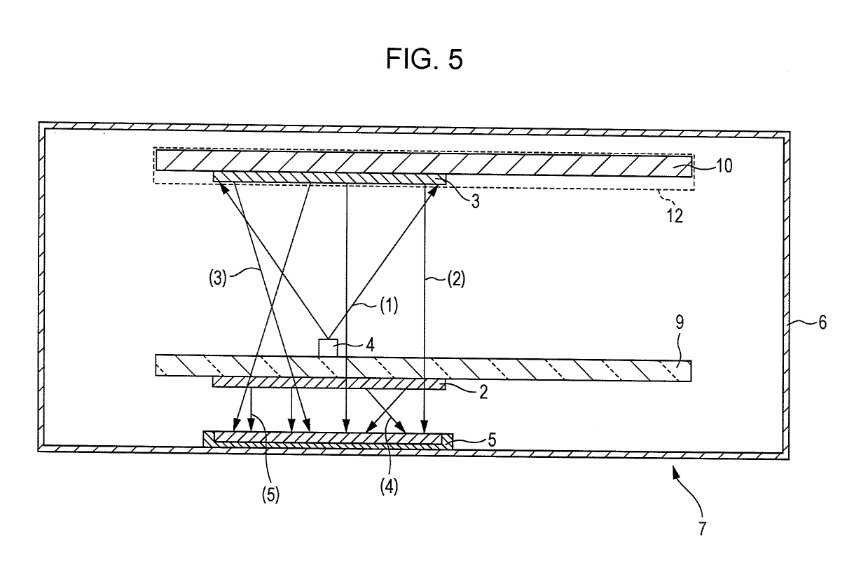

FIG. 5 illustrates a variation example of the configuration in FIG. 1. Referring to FIG. 5, the housing 6 may have an insertion opening 12 to which the card 10 having the second hologram 3 is insertable into the body 7 so that the second hologram 3 is insertable into the body 7.

In the configuration in FIG. 5, the first hologram 2, second hologram 3, light source 4 and image pickup device 5 may be built within the body 7.

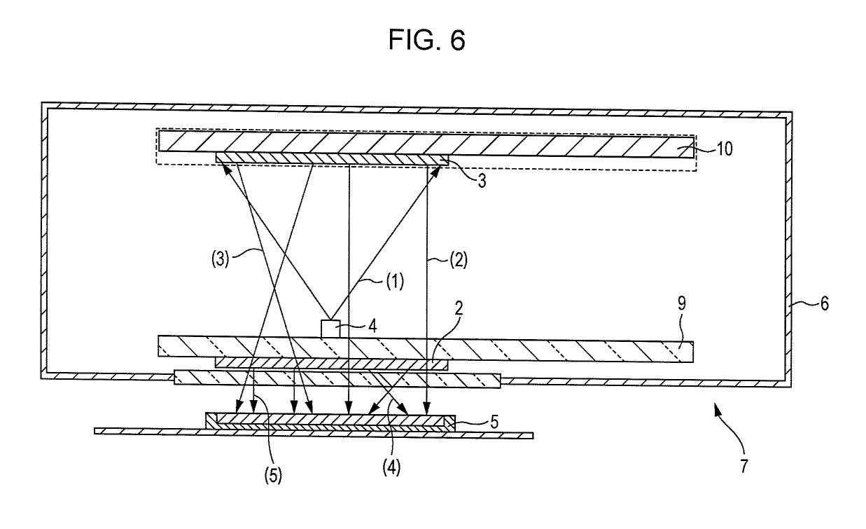

FIG. 6 illustrates a variation example of the configuration in FIG. 2. Referring to FIG. 6, the housing 6 may have the insertion opening 12 to which the card 10 having the second hologram 3 is insertable into the body 7 so that the second hologram 3 may be inserted into the body 7.

In the configuration in FIG. 6, the first hologram 2, second hologram 3, and light source 4 may be built in the body 7. The body 7 may be externally provided to the image pickup device 5.

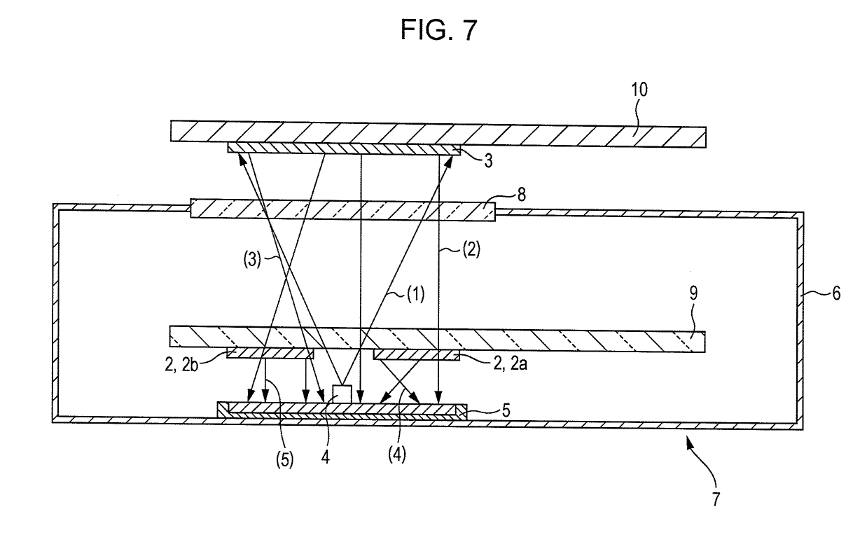

FIG. 7 illustrates a configuration in which the light source 4 is positioned between the first hologram 2 and the image pickup device 5, and the image pickup device 5, light source 4, first hologram 2 and second hologram 3 are arranged in the order from the bottom to the top of FIG. 7.

In the configuration in FIG. 7, to prevent transmission of light (reference light) (1) from the light source 3 through the first hologram 2, the second hologram 2 is designed to be divided into second holograms 2a and 2b so that the reference light(1) may pass between them. Thus, an optical system may be provided in which light from the light source 4 first reaches the second hologram 3, and the reflected light beams (diffracted light beams) (2) and (3) reflected by the second hologram 3 are irradiated as reference light to the first hologram 2 so that the diffracted light beams (4) and (5) may be obtained from the first hologram 2. Because this may prevent external leakage of data of the first hologram 2 and there is no danger of stealing the data of the first hologram 2, high security may be maintained.

Instead of the division of the first hologram 2 into the holograms 2a and 2b, the first hologram 2 may have a hole at the center, for example.

What is claimed is:

1. An authentication system comprising:
a first hologram;
a second hologram;
a light source; and
an image pickup device, wherein
the first hologram is a transmission hologram that causes interference with data of the second hologram in order to authenticate the second hologram;
the second hologram is a reflection hologram to be authenticated; and
light from the light source is reflected by the second hologram, the reflected light is irradiated to the first hologram as reference light for the first hologram, and diffracted light through the first hologram is acquired by the image pickup device to authenticate the second hologram.

2. The hologram authentication system according to claim 1, wherein the first hologram, the light source, the second hologram and the image pickup device are arranged coaxially.

3. The hologram authentication system according to claim 1, wherein the first hologram and the light source are arranged between the second hologram and the image pickup device.

4. The hologram authentication system according to claim 3, wherein the first hologram is arranged between the light source and the image pickup device.

5. The hologram authentication system according to claim 1, wherein the first hologram and the light source are arranged on one plate.

6. The hologram authentication system according to claim 5, wherein the first hologram and the light source face through the plate.

7. The hologram authentication system according to claim 1, wherein the first hologram, the light source and the image pickup device are built in a housing, which is configured a body.

8. The hologram authentication system according to claim 1, wherein
the first hologram and the light source are built in a housing to configure a body;
the body is provided externally to the image pickup device; and
the body has a counter face having a transmission window against the image pickup device.

9. The hologram authentication system according to claim 7, wherein the body has a transmission window at a position over which a card having the second hologram is held.

10. The hologram authentication system according to claim 7, wherein the body has an insertion opening to which a card having the second hologram is insertable into the body.
